(19) United States
(12) Patent Application Publication
(10) Pub. No.: US 2017/0316097 A1
(43) Pub. Date: Nov. 2, 2017

(54) Searching For Future Candidates

(71) Applicant: Linkedln Corporation, Mountain View, CA (US)

(72) Inventors: Igor Perisic, San Mateo, CA (US); Abhishek Gupta, San Francisco, CA (US); Shakti Dhirendraji Sinha, Sunnyvale, CA (US)

(21) Appl. No.: 15/140,990

(22) Filed: Apr. 28, 2016

(51) Int. Cl. G06F 17/30

(52) U.S. Cl. CPC G06F 17/30867; G06F 17/30477; G06F 17/30528

(57) ABSTRACT

Techniques for searching for future candidates are disclosed herein. In some example embodiments, a future candidate system determines one or more target candidate attributes based on user input, and identifies one or more precedent candidate attributes based on a sequential relationship between the one or more precedent candidate attributes and the one or more target candidate attributes, with the one or more precedent candidate attributes being different from and preceding the one or more target candidate attributes. In some example embodiments, the future candidate system identifies one or more candidates from among a plurality of candidates based on a determination that the one or more candidates comprise the one or more precedent candidate attributes, and causes the identified one or more candidates to be displayed on a client device.

### TECHNICAL FIELD

The present application relates generally to search and information retrieval and, in one specific example, to methods and systems of searching for future candidates.

### BACKGROUND

Conventionally, search results have been limited by how closely potential candidates presently satisfy the criteria of the search query. As a result, the search results fail to capture useful information regarding potential candidates that will satisfy the criteria in the future.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a future candidate system, in accordance with an example embodiment.

FIG. 4 depicts example member position sequences corresponding to members of a social network service, in accordance with an example embodiment.

FIG. 5 illustrates a graphical user interface (GUI) configured to receive user input for performing a candidate search, in accordance with an example embodiment.

FIG. 6 illustrates a GUI displaying candidate search results, in accordance with an example embodiment.

FIG. 7 is a flowchart illustrating a method of determining future candidates, in accordance with an example embodiment.

FIG. 8 is a flowchart illustrating a method of identifying one or more precedent candidate attributes, in accordance with an example embodiment.

FIG. 9 is a flowchart illustrating a method of determining an amount of time for one or more candidates to transition from one or more precedent candidate attributes to one or more target candidate attributes, in accordance with an example embodiment.

FIG. 10 is a block diagram illustrating a mobile device, in accordance with some example embodiments.

FIG. 11 is a block diagram of an example computer system on which methodologies described herein may be executed, in accordance with an example embodiment.

### DETAILED DESCRIPTION

Example methods and systems of searching for future candidates are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure introduces techniques of searching for future candidates. In some example embodiments, operations are performed by a machine having a memory and at least one processor, with the operations comprising: determining one or more target candidate attributes based on user input; identifying one or more precedent candidate attributes based on a sequential relationship between the one or more precedent candidate attributes and the one or more target candidate attributes, the one or more precedent candidate attributes being different from and preceding the one or more target candidate attributes; identifying one or more candidates from among a plurality of candidates based on a determination that the one or more candidates comprise the one or more precedent candidate attributes; and causing the identified one or more candidates to be displayed on a client device.

In some example embodiments, the sequential relationship comprises a consecutive relationship between the one or more precedent candidate attributes and the one or more target candidate attributes.

In some example embodiments, the identifying of the one or more precedent candidate attributes based on the sequential relationship comprises: identifying reference member profiles from among a plurality of member profiles of a social network service based on a determination that the reference member profiles comprise the target candidate attributes; and extracting the precedent candidate attributes from the reference member profiles.

In some example embodiments, the user input comprises an identification of a member profile of a social network service, and the one or more target candidate attributes are determined based on the member profile comprising the one or more target candidate attributes. In some example embodiments, the user input comprises the one or more target candidate attributes.

In some example embodiments, the operations further comprise: determining a corresponding amount of time for each one of the identified one or more candidates to transition from the one or more precedent candidate attributes to the one or more target candidate attributes; and causing the corresponding amount of time to be displayed on the client device concurrently with the identified one or more candidates. In some example embodiments, the corresponding amount of time is determined based on a corresponding amount of time for one or more reference member profiles of a social network service to transition from the one or more precedent candidate attributes to the one or more target candidate attributes.

In some example embodiments, the identifying of the one or more candidates from among the plurality of candidates is further based on a determination that the identified one or more candidates will transition from the precedent candidate attributes to the target candidate attributes with a predetermined amount of time. In some example embodiments, the user input comprises the predetermined amount of time.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

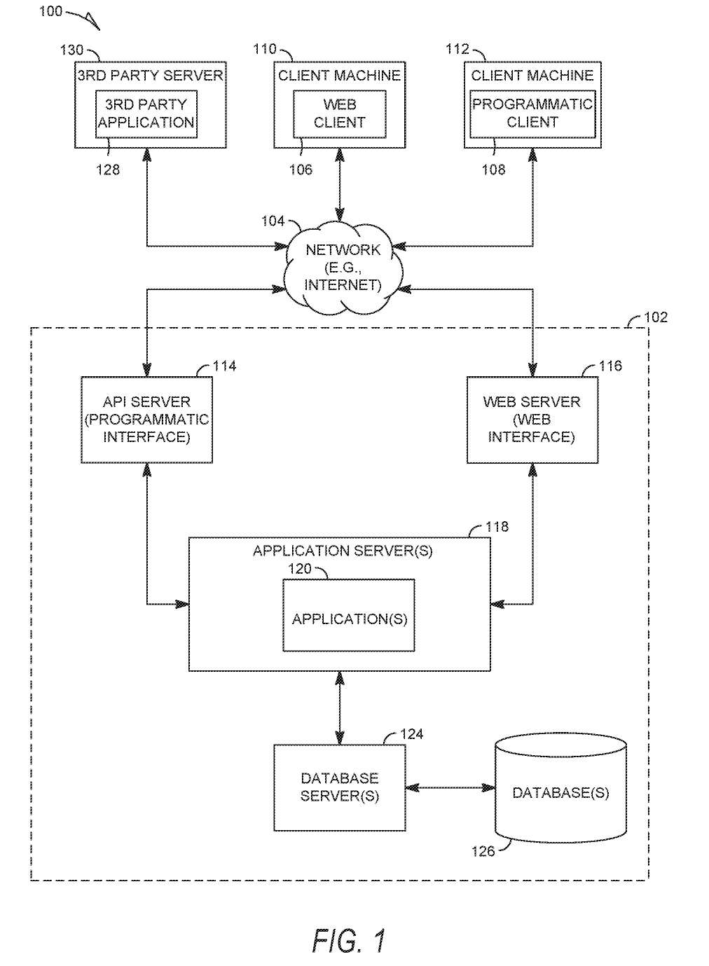

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

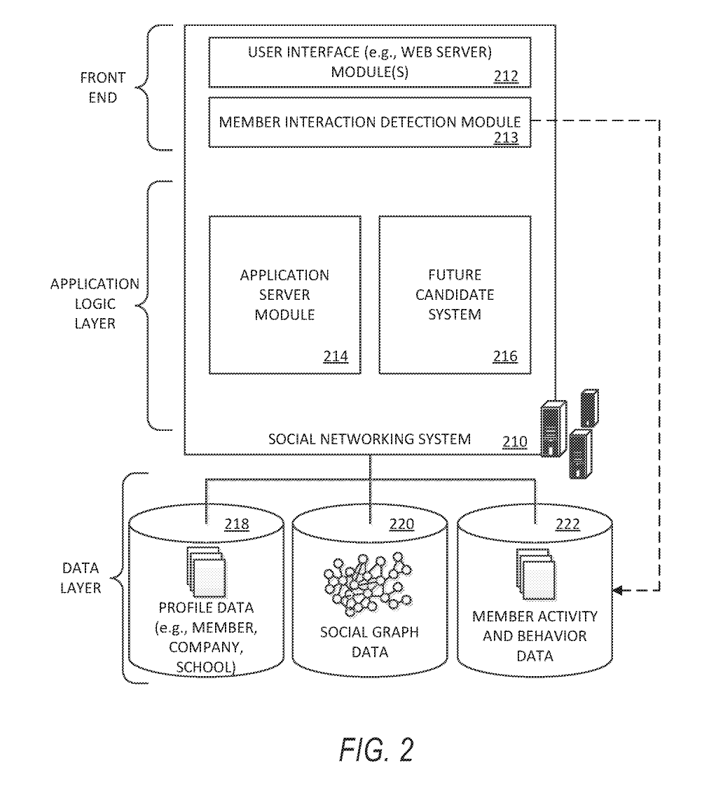

In some embodiments, the networked system 102 may comprise functional components of a social networking service. FIG. 2 is a block diagram showing the functional components of a social networking system 210, including a data processing module referred to herein as a future candidate system 216, for use in social networking system 210, consistent with some embodiments of the present disclosure. In some embodiments, the future candidate system 216 resides on application server 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the future candidate system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of“following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with reference number 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database with reference number 222. This logged activity information may then be used by the future candidate system 216.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the future candidate system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

In some example embodiments, an online service, such as a social networking service, provides services to members or other users. These services can include one or more services that determine one or more future candidates.

In some example embodiments, the future candidate system 216 is configured to identify candidates that are estimated to satisfy criteria, such as one or more target attributes, in the future. For example, the future candidate system 216 can identify candidates that may not currently have the target attributes, but that are estimated to have the target attributes within a certain period of time. The future candidate system 216 can display this information and/or can use this information in determining candidates to recommend to users, such as including these future candidates as part of search results. It is contemplated that the identification of these future candidates can be used in other ways as well.

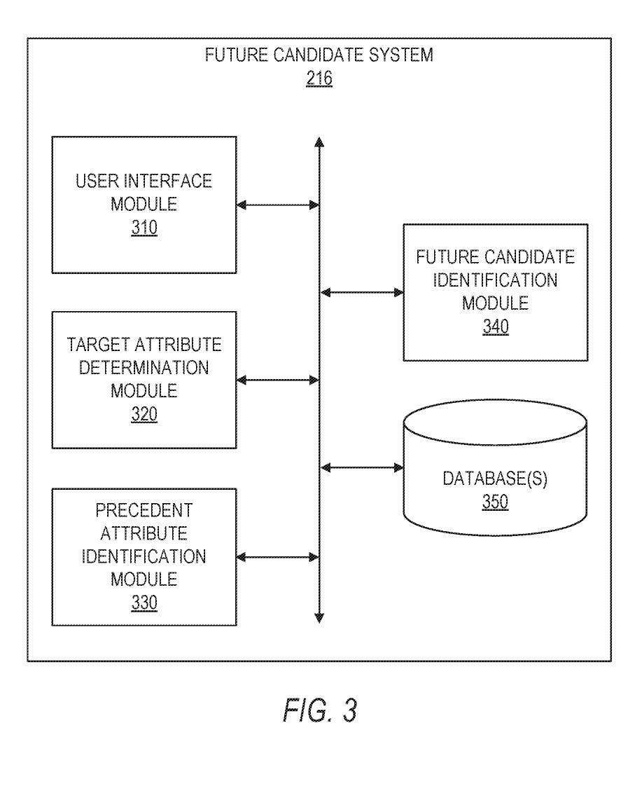

FIG. 3 is a block diagram illustrating components of the future candidate system 216, in accordance with an example embodiment. In some embodiments, the future candidate system 216 comprises any combination of one or more of a user interface module 310, a target attribute determination module 320, a precedent attribute identification module 330, a future candidate identification module 340, and one or more database(s) 350. The user interface module 310, the target attribute determination module 320, the precedent attribute identification module 330, the future candidate identification module 340, and the database(s) 350 can reside on a machine having a memory and at least one processor (not shown). In some embodiments, the user interface module 310, the target attribute determination module 320, the precedent attribute identification module 330, and the future candidate identification module 340 can be incorporated into the application server(s) 118 in FIG. 1. In some example embodiments, the database(s) 350 is incorporated into database(s) 126 in FIG. 1 and can include any combination of one or more of databases 218, 220, and 222 in FIG. 2. However, it is contemplated that other configurations of the modules 310, 320, 330, and 340, as well as the database(s) 350, are also within the scope of the present disclosure.

In some example embodiments, the user interface module 310 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth).

In some example embodiments, any combination of one or more of the modules 310, 320, 330, and 340 are configured to perform various communication functions to facilitate the functionality described herein, such as by communicating with the social networking system 210 via the network 140 using a wired or wireless connection. Any combination of one or more of the modules 310, 320, 330, and 340 may also provide various web services or functions such as retrieving information from the third party servers 130 and the social networking system 210. Information retrieved by the any of the modules 310, 320, 330, and/or 340 may include profile data corresponding to users and members of the social network service from the social networking system 210.

Additionally, any combination of one or more of the modules 310, 320, 330, and 340 can provide various data functionality, such as exchanging information with databases 350 or servers. For example, any of the modules 310, 320, 330, and 340 can access member profiles that include profile data from the database(s) 350, as well as extract attributes and/or characteristics from the profile data of member profiles. Furthermore, the one or more of the modules 310, 320, 330, and 340 can access social graph data and member activity and behavior data from database(s) 350, as well as exchange information with third party servers 130, client machines 110, 112, and other sources of information.

In some example embodiments, the user interface module 310 is configured to receive user input. For example, the user interface module 310 can present one or more GUI elements (e.g., drop-down menu, selectable buttons, text field) with which a user can submit input.

In some example embodiments, the target attribute determination module 320 is configured to determine one or more target candidate attributes based on user input. Examples of target candidate attributes include, but are not limited to, job title, job duration, job seniority level, pay level, industry, job skills, and company. Other attributes are also within the scope of the present disclosure. In some example embodiments, the user input received via the user interface module 310 comprises an explicit identification of the target candidate attribute(s). For example, the user input can comprise a job position (e.g., “senior software engineer”) and a duration that a candidate has been at that job position (e.g., “10 years”).

In some example embodiments, the user input comprises an identification of a member profile of a social network service, and the target attribute determination module 320 extracts the target candidate attribute(s) from the identified member profile. For example, the user input can identify “John Doe” and the target attribute determination module 320 can extract one or more target candidate attributes from a profile of John Doe.

In some example embodiments, the precedent attribute identification module 330 is configured to identify one or more precedent candidate attributes based on a sequential relationship between the one or more precedent candidate attributes and the one or more target candidate attributes. The one or more precedent candidate attributes are different from and precede the one or more target candidate attributes.

In some example embodiments, the precedent attribute identification module 330 performs a variety of analyses to facilitate the functionality described herein, such as analysing profile data and/or extracted attributes and/or characteristics from profile data. In a specific non-limiting example, the precedent attribute identification module 330 analyzes sequential relationships between positions of members to determine a particular set of positions. The precedent attribute identification module 330 can perform many other analyses.

Each position can comprise one or more attributes, such as those described above. A career path may be conceptualized as a sequence of positions in time that include a variety of attributes (e.g., industry, company, duration, seniority, pay level) associated with each position. Such sequences are often completely unique to an individual. However, a commonality may arise in various transitions from position to position. For instance, to achieve the position of principal of a school, an individual typically holds the position of vice-principal first. Online professional networks such as LinkedIn® maintain a dynamic, constantly updated and massive scale professional profile dataset spanning career records from hundreds of industries, millions of companies, and hundreds of millions of people worldwide. Analyzing the large body of profile data, including positions held by members, maintained by a social network service may allow sequential relationships representing likely transitions between positions to be identified.

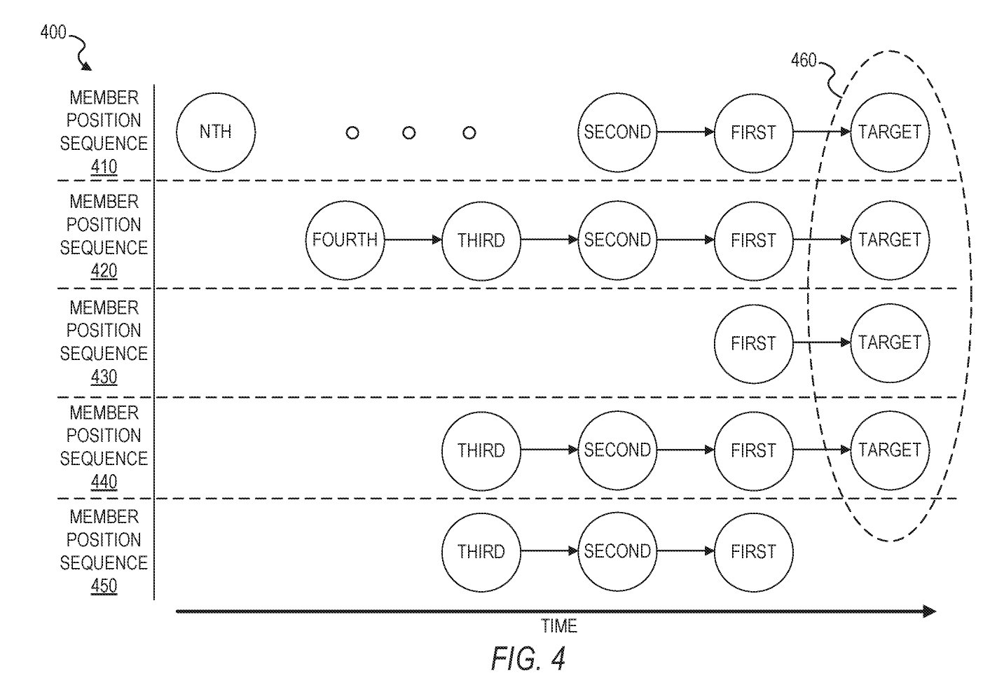

FIG. 4 depicts example member position sequences 400 corresponding to members of a social network service, in accordance with an example embodiment. The member position sequences 400 of FIG. 4 may be associated with members of the social network. Respective member position sequences 410, 420, 430, 440, and 450 may have any number of positions in a sequence. The member position sequences 400 may be ordered such that a first position in time is before a most recent position. For instance, the member position sequence 410 may include an nth position that is a first position and an mth position that is a most recent position in time.

In some example embodiments, the precedent attribute identification module 330 is configured to identify one or more precedent candidate attributes by identifying reference member profiles from among a plurality of member profiles of a social network service based on a determination that the reference member profiles comprise the target candidate attributes, and extract the precedent candidate attributes from the reference member profiles, with the precedent candidate attributes being based on common attributes of the reference member profiles.

For example, member position sequences 400 that include a target position representing the target candidate attribute(s), as illustrated by circle 460, may be identified by the precedent attribute identification module 330 as described herein. Thus, member position sequence 450 may not be identified and the positions, and thus attributes, included in member position sequence 450 may not be included in the extracted plurality of positions as described above. The member position sequences 410, 420, 430, and 440 may be identified by the precedent attribute identification module 330 and the positions, and thus attributes, included in the member positions sequences 410, 420, 430, and 440 may be included in the precedent candidate attributes.

The positions of FIG. 4 labeled “FIRST” may be positions that have a consecutive relationship with the origin position, labeled “TARGET.” In other words, the positions labeled “FIRST” are next to the target position in the member position sequences 400 without positions in-between. The precedent attribute identification module 330 can identify the positions labeled “FIRST” as having a consecutive relationship with the target positions and include the positions labeled “FIRST” in the set of precedent candidate attributes.

In some example embodiments, logic may be implemented to skip positions in the sequence. For instance, if the next position after the origin is determined to be skipped, the next position after the skipped position may have a consecutive relationship with the origin position. In an example embodiment, the precedent attribute identification module 330 can determine skip criteria to determine to skip a position. The skip criteria may include criteria such as duration of the positions, location of the position, seniority of the position, type of position (e.g., a temporary position versus a full time position), and so on. In a specific example, a teacher aspiring to become a principal may be temporarily out of work and may have accepted a position as a graphic designer while seeking a principal position at a school. The duration of the graphic designer position may be short and the teacher may subsequently accept a principal position at a school. Similarly, logic may be implemented to skip or ignore positions that are simultaneously held (e.g., a full time teacher working part time as a graphic designer). The precedent attribute identification module 330 can determine to skip the graphic designer position based on duration or other criteria.

In some example embodiments, the future candidate identification module 340 is configured to identify one or more candidates from among a plurality of candidates based on a determination that the one or more candidates comprise the one or more precedent candidate attributes.

In some example embodiments, the future candidate identification module 340 is configured to determine a corresponding amount of time for each one of the identified candidates to transition from the one or more precedent candidate attributes (e.g., position A) to the one or more target candidate attributes (e.g., position B). For example, the future candidate identification module 340 can estimate that it will take 5 months for a potential candidate to have the target candidate attributes given that the potential candidate currently has certain precedent candidate attributes. In some example embodiments, the future candidate identification module 340 is configured to filter candidates based on their corresponding amounts of time to transition to the target candidate attribute(s). For example, the future candidate attribute module 340 can restrict the list of identified candidates to those candidates that are estimated to have the target candidate attribute(s) within six months. In such an example, potential candidates estimated to transition to the target candidate attribute(s) within six months are identified as candidates, while potential candidates estimated to transition to the target candidate attribute(s) after six months are excluded from being identified as candidates. The threshold amount of time can be provided via user input.

In some example embodiments, the corresponding amounts of time for transitions from one or more precedent candidate attributes to one or more target candidate attributes are determined based on profile data of members that have made similar transitions. The profile data can indicate corresponding amounts of time it took for each of those members to make such a transition, and the corresponding amount of time can be estimated based on such an analysis of those corresponding amounts of time. For example, based on other members whose profile data indicates that it took them an average of seven months to make such a transition, the future candidate identification module 340 can estimate that it will take a potential candidate seven months to make the same transition.

In some example embodiments, the user interface module 310 is further configured to cause the identified candidate(s) to be displayed on a client device. For example, the user interface module 310 can cause the identified candidate(s) to be displayed on the client device as part of search results in response to a submitted search query, such as a candidate search performed by a recruiter. In some example embodiments, the user interface module 310 is further configured to cause the corresponding amount of time for a transition of an identified candidate to be displayed on the client device concurrently with that identified candidate.

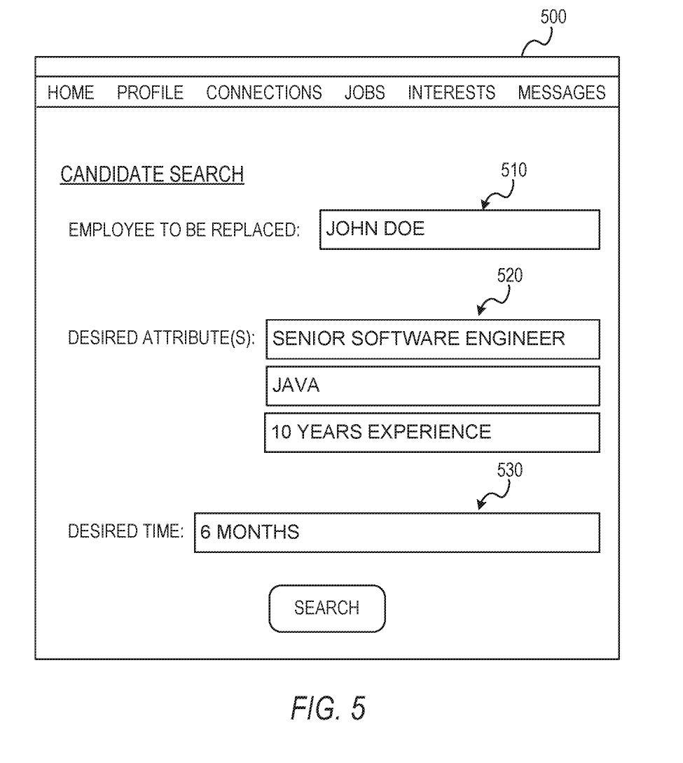

FIG. 5 illustrates a graphical user interface (GUI) 500 configured to receive user input for performing a candidate search, in accordance with an example embodiment. As seen in FIG. 5, a user (e.g., a recruiter) can provide input that can be used by the target attribute determination module 320 to determine one or more target candidate attributes. For example, the user can provide an identification 510 of a member profile of a social network service, such as “John Doe” in FIG. 5, in order to find candidates that are similar to “John Doe” (e.g., candidates having similar attributes as “John Doe”). The target attribute determination module 320 can access the identified member profile to extract the one or more target candidate attributes from the accessed member profile.

As seen in FIG. 5, the user can additionally or alternatively provide user input comprising one or more target candidate attributes 520. For example, the user can explicitly identify the target candidate attributes 520 that he or she is seeking (e.g., a senior software engineer skilled in Java and having at least ten years of experience).

Additionally, the user can provide a desired amount of time 530 in which they want candidates to have transitioned to the target candidate attribute(s). For example, the user can provide input indicating that he or she is searching for candidates that will be a senior software engineer skilled in Java and have at least ten years of experience within six months.

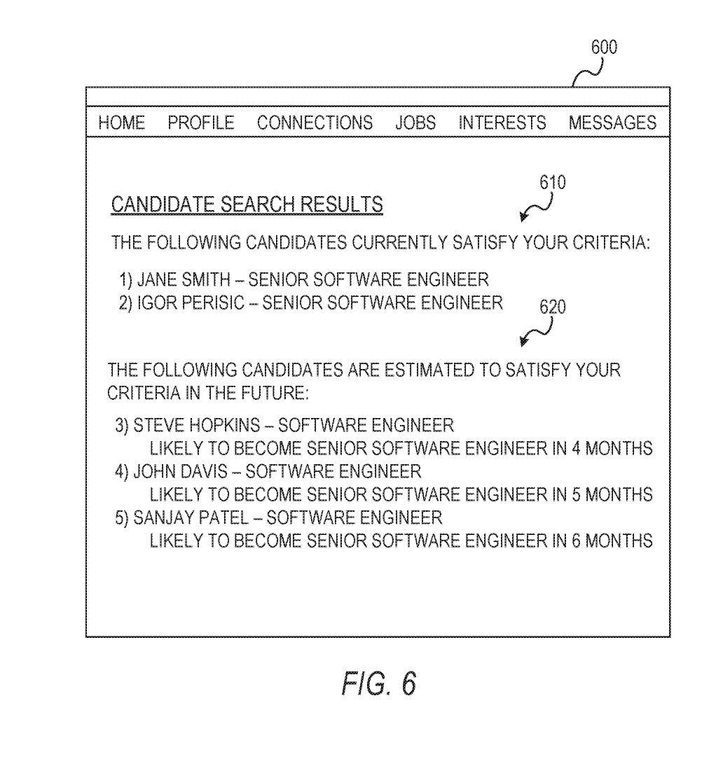

FIG. 6 illustrates a GUI 600 displaying candidate search results, in accordance with an example embodiment. As seen in FIG. 6, the search results can include an indication 610 of one or more candidates that currently have the target candidate attribute(s). In some example embodiments, the indication 610 of candidates includes an identification, such as a name, of each candidate, and may also include their current job title or position (e.g., Senior Software Engineer). In some example embodiments, the search results can also include an indication 620 of one or more candidates that are identified by the future candidate identification module 340 as being estimated to transition to the target candidate attribute(s) in the future, thus qualifying as future candidates. In some example embodiments, the future candidate identification module 340 determines a corresponding amount of time for each one of the identified candidates to transition to the target candidate attribute(s) (e.g., four months for Steve Hopkins, five months for John Davis, six months for Sanjay Patel), and the corresponding amounts of time are caused to be displayed concurrently with the identified candidates. In some example embodiments, the indication 620 of the one or more candidate that are identified as being estimated to transition to the target candidate attribute(s) in the future includes an identification, such as a name, of each candidate, and may also include their current job title or position (e.g., Software Engineer) and the corresponding determined amount of time for each respective candidate to transition to the target candidate attribute(s) (e.g., “likely to become Senior Software Engineer in 4 months”).

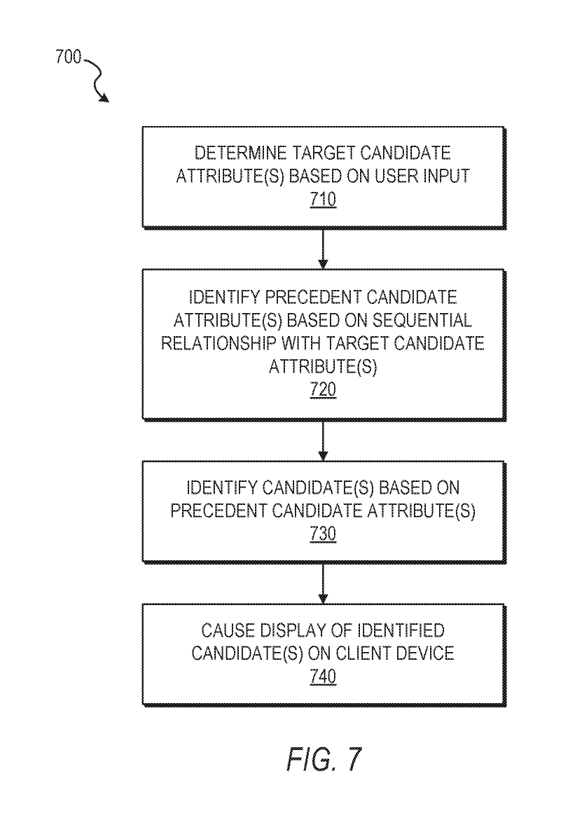

FIG. 7 is a flowchart illustrating a method 700 of determining future candidates, in accordance with an example embodiment. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the future candidate system 216 of FIGS. 2-3, or any combination of one or more of its modules, as described above.

At operation 710, one or more target candidate attributes based on user input are determined. In some example embodiments, the user input comprises an identification of a member profile of a social network service. In some example embodiments, the user input comprises the one or more target candidate attributes. In some example embodiments, the user input comprises the predetermined amount of time. At operation 720, one or more precedent candidate attributes are identified based on a sequential relationship between the one or more precedent candidate attributes and the one or more target candidate attributes, with the one or more precedent candidate attributes being different from and preceding the one or more target candidate attributes. In some example embodiments, the sequential relationship comprises a consecutive relationship between the one or more precedent candidate attributes and the one or more target candidate attributes. At operation 730, one or more candidates are identified from among a plurality of candidates based on a determination that the one or more candidates comprise the one or more precedent candidate attributes. In some example embodiments, the identifying of the one or more candidates from among the plurality of candidates is further based on a determination that the identified one or more candidates will transition from the precedent candidate attributes to the target candidate attributes with a predetermined amount of time. At operation 740, the identified one or more candidates are caused to be displayed on a client device.

It is contemplated that any of the other features described within the present disclosure can be incorporated into method 700.

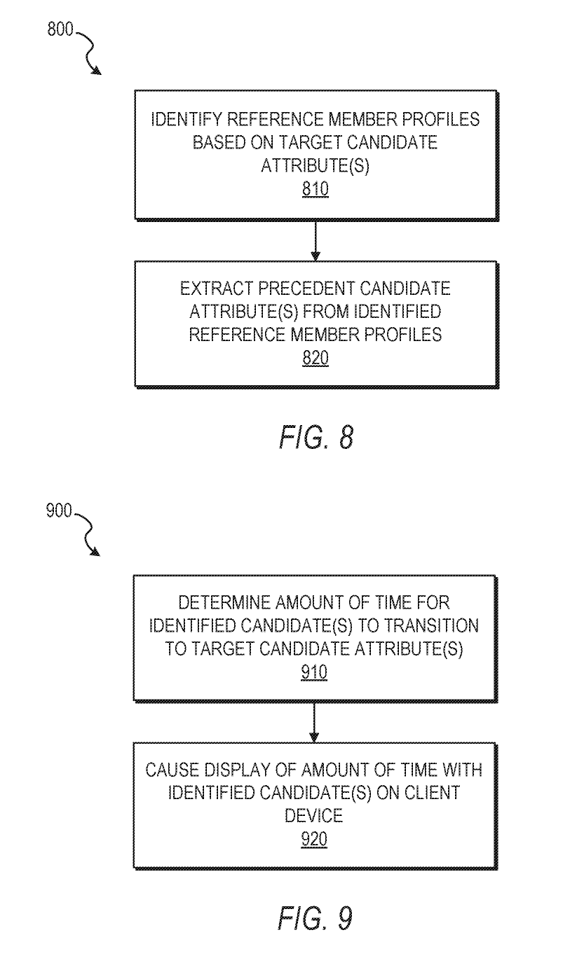

FIG. 8 is a flowchart illustrating a method 800 of identifying one or more precedent candidate attributes, in accordance with an example embodiment. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the future candidate system 216 of FIGS. 2-3, or any combination of one or more of its modules, as described above.

At operation 810, reference member profiles are identified from among a plurality of member profiles of a social network service based on a determination that the reference member profiles comprise the target candidate attributes. At operation 820, the precedent candidate attributes are extracted from the reference member profiles.

It is contemplated that any of the other features described within the present disclosure can be incorporated into method 800.

FIG. 9 is a flowchart illustrating a method 900 of determining an amount of time for one or more candidates to transition from one or more precedent candidate attributes to one or more target candidate attributes, in accordance with an example embodiment. Method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the future candidate system 216 of FIGS. 2-3, or any combination of one or more of its modules, as described above.

At operation 910, a corresponding amount of time for each one of the identified one or more candidates to transition from the one or more precedent candidate attributes to the one or more target candidate attributes is determined. In some example embodiments, the corresponding amount of time is determined based on a corresponding amount of time for one or more reference member profiles of a social network service to transition from the one or more precedent candidate attributes to the one or more target candidate attributes. At operation 920, the corresponding amount of time is caused to be displayed on the client device concurrently with the identified one or more candidates.

It is contemplated that any of the other features described within the present disclosure can be incorporated into method 900.

### Example Mobile Device

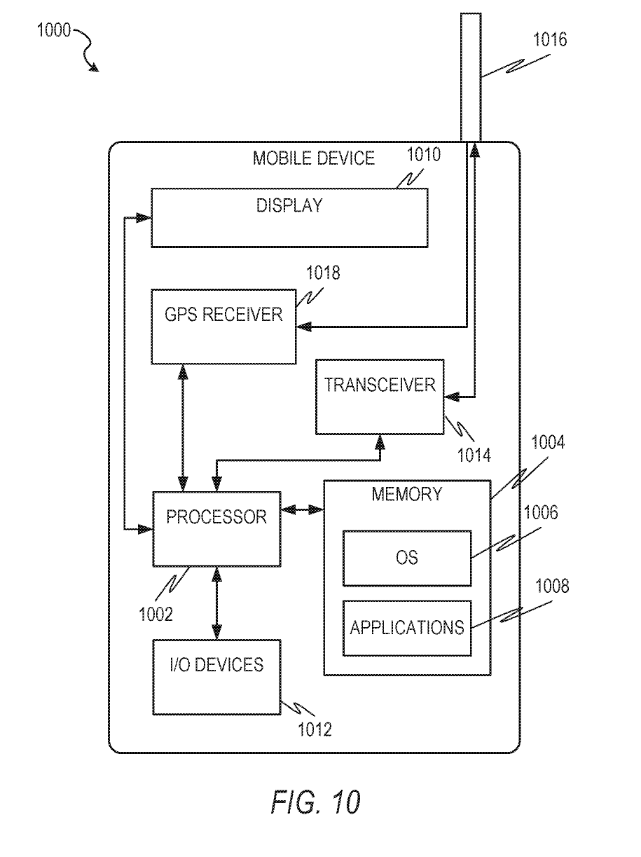

FIG. 10 is a block diagram illustrating a mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1004, such as a random access memory (RAM), a Flash memory, or other type of memory, is typically accessible to the processor 1002. The memory 1004 can be adapted to store an operating system (OS) 1006, as well as application programs 1008, such as a mobile location enabled application that can provide location-based services (LBSs) to a user. The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

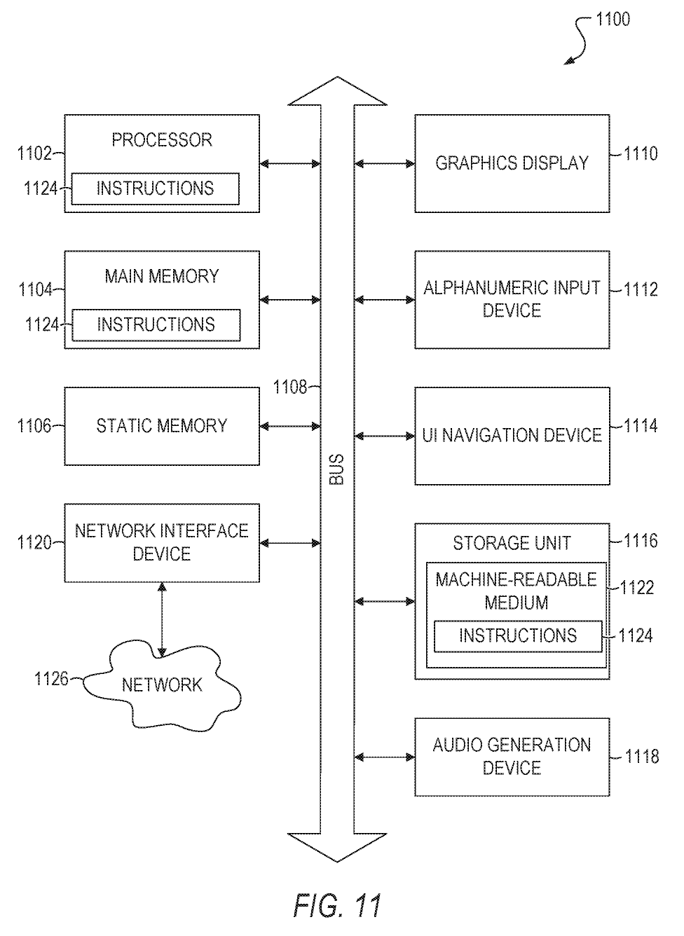

FIG. 11 is a block diagram of an example computer system 1100 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining one or more target candidate attributes based on user input;
identifying, by a machine having a memory and at least one processor, one or more precedent candidate attributes based on a sequential relationship between the one or more precedent candidate attributes and the one or more target candidate attributes, the one or more precedent candidate attributes being different from and preceding the one or more target candidate attributes;
identifying one or more candidates from among a plurality of candidates based on a determination that the one or more candidates comprise the one or more precedent candidate attributes; and
causing the identified one or more candidates to be displayed on a client device.

2. The computer-implemented method of claim 1, wherein the sequential relationship comprises a consecutive relationship between the one or more precedent candidate attributes and the one or more target candidate attributes.

3. The computer-implemented method of claim 1, wherein the identifying of the one or more precedent candidate attributes based on the sequential relationship comprises:
identifying reference member profiles from among a plurality of member profiles of a social network service based on a determination that the reference member profiles comprise the target candidate attributes; and
extracting the precedent candidate attributes from the reference member profiles.

4. The computer-implemented method of claim 1, wherein the user input comprises an identification of a member profile of a social network service, and the one or more target candidate attributes are determined based on the member profile comprising the one or more target candidate attributes.

5. The computer-implemented method of claim 1, wherein the user input comprises the one or more target candidate attributes.

6. The computer-implemented method of claim 1, further comprising:
determining a corresponding amount of time for each one of the identified one or more candidates to transition from the one or more precedent candidate attributes to the one or more target candidate attributes; and
causing the corresponding amount of time to be displayed on the client device concurrently with the identified one or more candidates.

7. The computer-implemented method of claim 6, wherein the corresponding amount of time is determined based on corresponding amount of time for one or more reference member profiles of a social network service to transition from the one or more precedent candidate attributes to the one or more target candidate attributes.

8. The computer-implemented method of claim 1, wherein the identifying of the one or more candidates from among the plurality of candidates is further based on a determination that the identified one or more candidates will transition from the precedent candidate attributes to the target candidate attributes with a predetermined amount of time.

9. The computer-implemented method of claim 8, wherein the user input comprises the predetermined amount of time.

10. A system comprising:
at least one processor; and
a non-transitory machine-readable medium embodying a set of instructions that, when executed by the at least one processor, cause the at least one processor to perform operations, the operations comprising:
determining one or more target candidate attributes based on user input;
identifying one or more precedent candidate attributes based on a sequential relationship between the one or more precedent candidate attributes and the one or more target candidate attributes, the one or more precedent candidate attributes being different from and preceding the one or more target candidate attributes;
identifying one or more candidates from among a plurality of candidates based on a determination that the one or more candidates comprise the one or more precedent candidate attributes; and
causing the identified one or more candidates to be displayed on a client device.

11. The system of claim 10, wherein the sequential relationship comprises a consecutive relationship between the one or more precedent candidate attributes and the one or more target candidate attributes.

12. The system of claim 10, wherein the identifying of the one or more precedent candidate attributes based on the sequential relationship comprises:
identifying reference member profiles from among a plurality of member profiles of a social network service based on a determination that the reference member profiles comprise the target candidate attributes; and
extracting the precedent candidate attributes from the reference member profiles.

13. The system of claim 10, wherein the user input comprises an identification of a member profile of a social network service, and the one or more target candidate attributes are determined based on the member profile comprising the one or more target candidate attributes.

14. The system of claim 10, wherein the user input comprises the one or more target candidate attributes.

15. The system of claim 10, wherein the operations further comprise:
determining a corresponding amount of time for each one of the identified one or more candidates to transition from the one or more precedent candidate attributes to the one or more target candidate attributes; and
causing the corresponding amount of time to be displayed on the client device concurrently with the identified one or more candidates.

16. The system of claim 5, wherein the corresponding amount of time is determined based on corresponding amount of time for one or more reference member profiles of a social network service to transition from the one or more precedent candidate attributes to the one or more target candidate attributes.

17. The system of claim 1, wherein the identifying of the one or more candidates from among the plurality of candidates is further based on a determination that the identified one or more candidates will transition from the precedent candidate attributes to the target candidate attributes within a predetermined amount of time.

18. The system of claim 17, wherein the user input comprises the predetermined amount of time.

19. A non-transitory machine-readable medium embodying a set of instructions that, when executed by a processor, cause the processor to perform operations, the operations comprising:
determining one or more target candidate attributes based on user input;
identifying one or more precedent candidate attributes based on a sequential relationship between the one or more precedent candidate attributes and the one or more target candidate attributes, the one or more precedent candidate attributes being different from and preceding the one or more target candidate attributes;
identifying one or more candidates from among a plurality of candidates based on a determination that the one or more candidates comprise the one or more precedent candidate attributes; and
causing the identified one or more candidates to be displayed on a client device.

20. The non-transitory machine-readable medium of claim 19, wherein the identifying of the one or more precedent candidate attributes based on the sequential relationship comprises:
identifying reference member profiles from among a plurality of member profiles of a social network service based on a determination that the reference member profiles comprise the target candidate attributes; and
extracting the precedent candidate attributes from the reference member profiles.
